(19) United States
(12) Patent Application Publication
(10) Pub. No.: US 2015/0268040 A1
(43) Pub. Date: Sep. 24, 2015

(54) LASER PROCESSING DEVICE HAVING FUNCTION FOR MONITORING PROPAGATION OF LASER BEAM

(71) Applicant: FANUC CORPORATION, Minamitsuru-gun (JP)

(72) Inventor: Takashi Izumi, Yamanashi (JP)

(73) Assignee: FANUC CORPORATION, Minamitsuru-gun (JP)

(21) Appl. No.: 14/665,528

(22) Filed: Mar. 23, 2015

(30) Foreign Application Priority Data
Mar. 24, 2014 (JP) 2014-060649

(51) Int. Cl. G01B 21/24

(52) U.S. Cl. CPC G01B 21/24

(57) ABSTRACT

A laser processing device having a simple structure and a means for accurately detecting expansion and misalignment of a laser beam. A sensor, which receives the laser beam after transmitting through a half mirror, is arranged on a back surface of the half mirror opposed to a front surface which reflects the laser beam. The sensor is positioned via a heat insulating material between the back surface of the half mirror and a shield plate for shielding or absorbing the laser beam after transmitting through the half mirror, so that the sensor is thermally-independent from the other components. The sensor is positioned so that the sensor does not receive the laser beam after transmitting through the half mirror in the normal state, and so that the sensor directly receives the laser beam after transmitting through the half mirror when the laser beam is expanded or misaligned.

### BACKGROUND OF THE INVENTION

1. Field of the Invention

The present invention relates to a laser processing device having a function for monitoring propagation of a laser beam.

2. Description of the Related Art

In a laser processing device having a gas laser oscillator, a laser beam which is output from the laser oscillator propagates through the atmosphere and is introduced to a processing point via one or more reflecting mirror. Normally, in order to introduce the laser beam to the processing point, a beam path enclosed by a bellows or a duct is purged by using clean gas.

The bellows for constituting the beam path is expanded or contracted when laser processing, and therefore outside air may enter the beam path from a seam of the bellows or a gap between an end of the bellows and a packing arranged at the seam. In the prior art, when a paint or thinner is used in a factory where the laser processing device is located, impurity gas may enter the beam path so that (a diameter of) the laser beam is expanded, whereby the laser processing may be disadvantageously affected. Further, a beam axis may be shifted or misaligned due to vibration of peripheral equipment. Therefore, it is preferable that the laser processing device be provided with an apparatus for monitoring or detecting the misalignment of the beam axis.

In general, in order to monitor the expansion or misalignment of the laser beam, the following three options may be used.

(a) An aperture (or a plate having an opening) is arranged coaxially with the beam path, and the temperature of the aperture or a reflected beam from the aperture is monitored.

(b) A gas sensor is arranged in the beam path, and it is monitored as to whether gas or a particle which may negatively affect the propagation of the laser beam exists in the beam path.

(c) A half mirror is arranged on the beam path, and the laser beam dispersed by the half mirror is monitored by means of a beam profiler.

As a conventional technique regarding option (a), JP H07-290259 A discloses an abnormal laser beam detecting device, in which an aperture member having an aperture is positioned on an optical propagation path, an incidence side of the aperture member is formed as a concave mirror, and a detector is positioned at a focal point of the concave mirror.

Further, JP 2000-094172 A discloses a laser beam axis misalignment detecting device having a base block having a hole (aperture) through which a laser beam passes, an infrared sensor inserted into a hole formed on an inner surface of the aperture, and a reflection plate having an aperture, having a tapered edge, having a smaller diameter than the aperture of the base block. In this device, when the beam axis is misaligned, a reflected light from the reflection plate enters the infrared sensor.

As a conventional technique regarding option (b), JP H05-212575 A discloses a laser processing device, in which a smoke-detection sensor is arranged within a light guiding path so as to detect a transmittance in the guiding path.

As another conventional technique for monitoring the diameter of a laser beam, JP H03-070876 U discloses a laser processing device having a partial transmission mirror, in which a center portion of the mirror is formed as a total reflecting part, and a peripheral portion thereof is formed as a transmitting part. In this device, a change in the diameter of the laser beam can be detected by monitoring a light after transmitting through the partial transmission mirror.

Although a monitoring method (a) using an aperture, as described in JP H07-290259 A or JP 2000-094172 A, is the most common, this method includes the following technical problems.

(a1) In view of a response of the sensor, it is preferable that the diameter of the aperture be small as possible. However, as the aperture diameter becomes smaller, the characteristic of the laser beam is affected. Further, when the aperture member is irradiated with a laser beam having significant power, heat deformation of the aperture member and/or evaporation of a coating of the aperture member may occur, whereby the reflecting mirror may be contaminated.

(a2) Since a reflected light from the aperture has certain degree of power, it is necessary to prepare means for attenuating the reflected light in order to protect a sensor from the reflected light. On the other hand, laser processing is carries out at various output powers depending on an object to be processed. Therefore, when the laser processing is carried out at relatively low output power, the sensor may not detect the laser beam attenuated by the above means. Further, when the reflected light is used (i.e., the laser beam is indirectly monitored), the response of the sensor may be delayed.

(a3) Since a part of the beam path is narrowed by the aperture, purge gas cannot smoothly flow within the beam path when purging, whereby the purge gas easily stagnates in the beam path.

A monitoring method (b) using a gas sensor, as described in JP H05-212575 A includes the following technical problems.

(b1) There are many kinds of gases which may affect the propagation of the laser beam (for example, sulfur hexafluoride, ethylene, halogenated hydrocarbon, ammonia, acetone, alcohol, carbon dioxide, etc.). Therefore, it may be necessary to prepare some kinds of gas sensors depending on the kinds of gases.

(b2) In order to purge the beam path, various kinds of gases are used (for example, air, dry air, nitrogen, air including reduced carbon dioxide, etc.). Therefore, the gas sensor may not be stably operated, e.g., an output of the gas sensor may include an offset (or offset voltage), and/or an alarm may be output even when the beam path is in a normal state.

(b3) Fine particles such as dust may affect the propagation of the laser beam, whereas a normal gas sensor cannot detect particles.

In addition, in a method (c) for dispersing a laser beam and monitoring it by means of a profiler, an apparatus therefor is relatively large, complicated and expensive. Therefore, it is difficult to apply method (c) to a mass-production system.

On the other hand, the technique described in JP H03-070876 U uses a partial transmitting mirror having the center portion formed as the total reflecting part and the peripheral portion thereof formed as the transmitting part. Therefore, it can be detected that the diameter of the laser beam is decreased when the laser beam does not transmit through the peripheral portion. However, in a normal state, since the laser beam transmits through the peripheral portion and the transmitted laser beam is received by the sensor, the expansion of the laser beam (or the laser diameter) relative to the normal state cannot be detected. In addition, it may be difficult to manufacture the partial transmitting mirror having the circular center total reflecting portion and the peripheral portion thereof. Further, when an outer peripheral portion of the partial transmitting mirror is irradiated with the laser beam, it is difficult to estimate reflection, absorption and subsequent diffraction of the laser beam.

### SUMMARY OF THE INVENTION

An object of the present invention is to provide a laser processing device having a simple structure and a means for accurately detecting expansion and misalignment of a laser beam.

Accordingly, the invention provides a laser processing device comprising: a laser oscillator; a beam path through which a laser beam, which is output from the laser oscillator, transmits; and at least one reflecting mirror positioned in the beam path, the laser beam propagating within the beam path, wherein the at least one reflecting mirror includes at least one half mirror, and at least one sensor is arranged on a surface of the half mirror opposed to a surface where the laser beam is reflected, the sensor being configured to receive the laser beam after transmitting through the half mirror, and wherein the sensor is positioned so that the sensor does not receive the laser beam in a normal state, and so that the sensor receives the laser beam when the laser beam is expanded relative to the normal state or when a beam axis of the laser beam is misaligned relative to the normal state.

In a preferred embodiment, the at least one sensor includes a plurality of sensors, and the sensors are positioned at equal distances on a circumference of a having a diameter larger than a diameter of the laser beam after transmitting through the half mirror, or on a circumference of an ellipse having a minor radius larger than the diameter of the laser beam after transmitting through the half mirror.

In a preferred embodiment, the sensor is configured to directly receive the laser beam after transmitting through the half mirror.

In a preferred embodiment, the laser processing device further comprises a mirror temperature sensor configured to measure a temperature of the half mirror.

In a preferred embodiment, the sensor is selected from a group including a thermocouple, a temperature switch, a thermostat, a thermopile, and a platinum resistance temperature detector.

In a preferred embodiment, the laser processing device further comprises an alarm outputting part configured to output an alarm when the sensor receives the laser beam.

### BRIEF DESCRIPTION OF THE DRAWINGS

The above and other objects, features and advantages of the present invention will be made more apparent by the following description of the preferred embodiments thereof, with reference to the accompanying drawings, wherein:

FIG. 1 shows a schematic configuration of a laser processing device according to a preferred embodiment of the present invention;

FIG. 2a shows an example wherein one thermocouple is arranged on a back surface of a half mirror;

FIG. 2b shows an example wherein a thermopile is arranged on a back surface of a half mirror;

FIG. 2c shows an example wherein three thermostats are arranged on a back surface of a half mirror;

FIG. 2d shows an example wherein three thermocouples and three platinum resistance temperature detectors are arranged on a back surface of a half mirror;

FIG. 2e shows an example wherein a temperature switch is arranged on a back surface of a half mirror, and a thermocouple for measuring the temperature of the half mirror is arranged on a front surface of the half mirror;

FIG. 2f shows an example wherein one thermocouple is arranged on a back surface of a half mirror, and a light receiving part is arranged on a front side of the thermocouple;

FIG. 3a is a cross-sectional view in the direction of a laser beam axis of configurations of FIGS. 2a, 2b and 2c;

FIG. 3b is a cross-sectional view in the direction of a laser beam axis of a configuration of FIG. 2d;

FIG. 3c is a cross-sectional view in the direction of a laser beam axis of a configuration of FIG. 2e;

FIG. 3d is a cross-sectional view in the direction of a laser beam axis of a configuration of FIG. 2f;

FIG. 4a shows that the laser beam is expanded in the configuration of FIG. 2a;

FIG. 4b shows that the laser beam is expanded in the configuration of FIG. 2b;

FIG. 4c shows that the laser beam is expanded in the configuration of FIG. 2c;

FIG. 5a shows that the laser beam axis is misaligned in the configuration of FIG. 2a;

FIG. 5b shows that the laser beam axis is misaligned in the configuration of FIG. 2b;

FIG. 5c shows that the laser beam axis is misaligned in the configuration of FIG. 2c;

FIG. 6 is a flowchart showing a procedure when the half mirror having the configuration of FIG. 2a, 2b or 2f is used;

FIG. 7 is a flowchart showing a procedure when the half mirror having the configuration of FIG. 2c is used;

FIG. 8 is a flowchart showing a procedure when the half mirror having the configuration of FIG. 2d is used;

FIG. 9 is a flowchart showing a procedure when the half mirror having the configuration of FIG. 2e is used;

FIG. 10 is a flowchart showing a procedure when two half mirrors each having a sensor at a back side thereof are used; and

FIG. 11 is a graph showing propagation characteristics of a laser beam.

### DETAILED DESCRIPTIONS

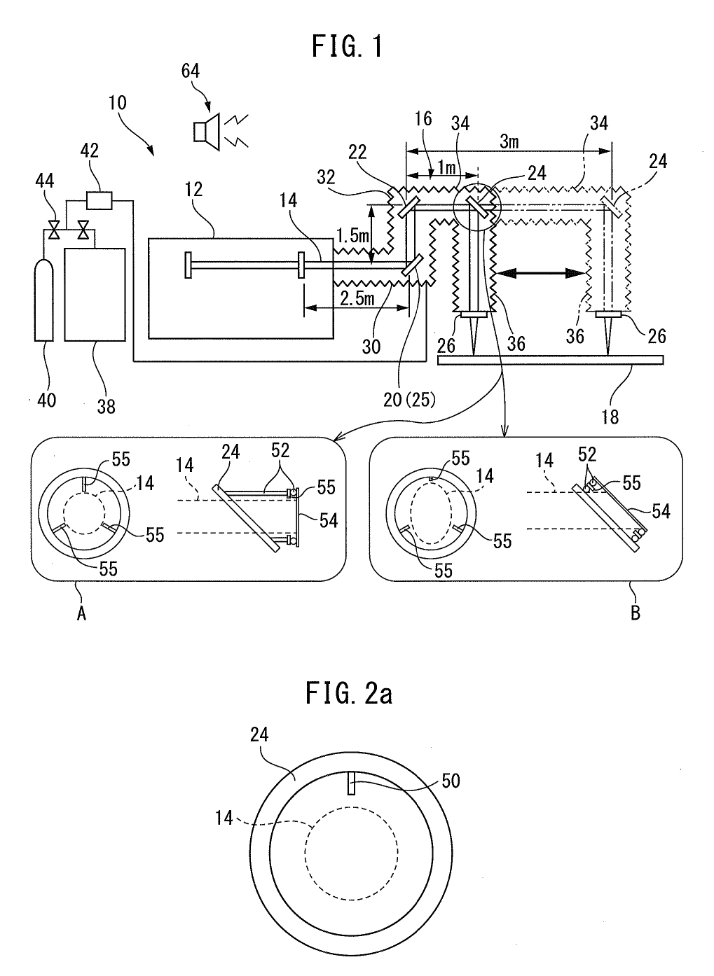

FIG. 1 shows a schematic configuration of a laser processing device according to a preferred embodiment of the present invention. Laser processing device 10 includes a gas laser oscillator 12, a laser medium of which is carbon dioxide, etc.; a beam path (or a laser transmission path) 16 through which a laser beam 14 output from laser oscillator 12 passes; and at least one reflecting mirror positioned in beam path 16, wherein laser beam 14 propagates within beam path 16 and is introduced to a workpiece 18 to be processed. In the illustrated embodiment, laser beam 14 irradiated from laser oscillator 12 is totally reflected by a first reflecting mirror 20 and a second reflecting mirror 22, is reflected by a movable half mirror (or a partially transmitting mirror) 24, and then transmits through a movable process lens 26 so that a predetermined processing is carried out with respect to workpiece 18. In addition, dimensions indicated in FIG. 1 are merely examples, and the present invention is not limited to the configuration having such dimensions.

Beam path 16 has an enclosed structure constituted by a bellows. In the embodiment of FIG. 1, four bellows 30, 32, 34 and 36 are connected in this order, so that neighboring bellows are generally orthogonal to each other. Due to expansion or contraction of bellows 34 (in the horizontal direction, in FIG. 1), half mirror 24 and process lens 26 can be moved. In addition, among components constituting beam path 16, a component which does not include the movable part (half mirror 24 and process lens 26) may be manufactured by a substantially rigid duct, etc., instead of the bellows.

Laser processing device 10 includes a compressor 38 which generates purge dry air (or clean air) to be supplied to beam path 16; a gas cylinder 40 within which purge nitrogen gas is enclosed; and a switching valve 44 fluidly connected to beam path 16 via an air filter 42. By operating switching valve 44, the purge gas supplied to beam path 16 can be switched between clean air and nitrogen.

As reflecting mirrors 20 and 22, a metallic mirror such as a copper mirror, a molybdenum mirror or an aluminum mirror may be used. Otherwise, a mirror having high reflectivity and low absorbance of carbon dioxide laser, such as a silicon-based mirror, may be used. On the other hand, as half mirror 24, a mirror which reflects more than 98% of carbon dioxide laser and transmits the rest (2% or less), such as a zinc selenide (ZnSe) mirror, a germanium mirror or a gallium arsenide (GaAs) mirror, may be used. In addition, although a reflection angle of the laser beam at each mirror is illustrated as 90 degrees, the present invention is not limited to as such.

Process lens 26 has a function for condensing laser beam 14 onto workpiece 18. A packing, etc., is arranged at a boundary between process lens 26 and bellows 36, whereby ambient air or assist gas is prevented from entering beam path 16. Similarly, a packing is arranged between the neighboring bellows constituting beam path 16, whereby ambient air is prevented from entering beam path 16. In the embodiment of FIG. 1, laser processing is carried out while process lens 26 is moved in the horizontal direction due to expansion/contraction of bellows 34. In this regard, laser processing device 10 may have another axis which is movable in the front-back direction (or the direction perpendicular to the drawing) or in the vertical direction. Also in this case, a stretchable bellows is used as the movable part so as to enclose the beam path.

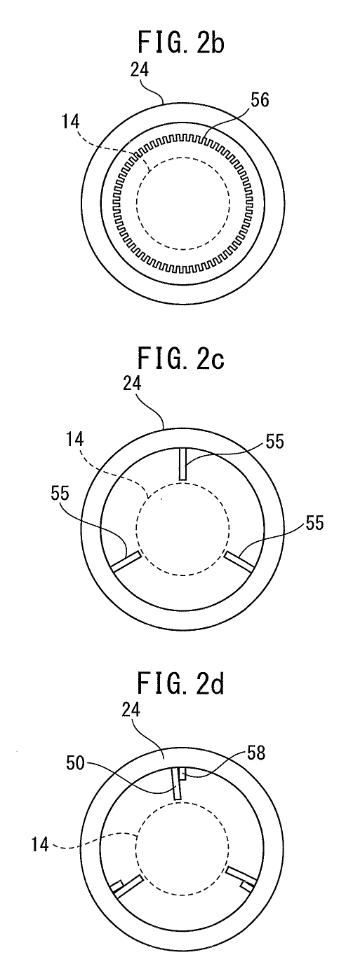

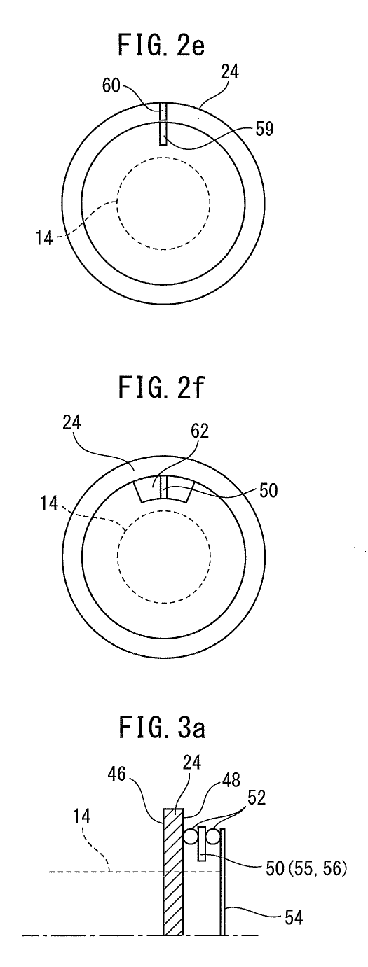

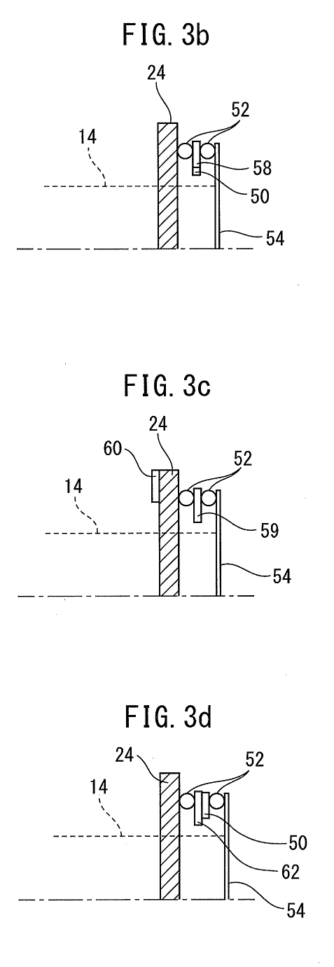

Next, concrete examples of a sensor arranged on half mirror 24 will be explained with reference to FIGS. 2a to 2f, and 3a to 3d. In this regard, FIG. 3a shows a cross-section in the direction of the laser beam axis of configurations of FIGS. 2a to 2c, and FIGS. 3b to 3d show cross-sections in the direction of the beam axis of configurations of FIGS. 2d to 2f, respectively.

FIG. 2a (3a) shows an example wherein one sensor 50, which receives the laser beam after transmitting through half mirror 24, is arranged on a (back) surface 48 of half mirror 24 opposed to a (front) surface 46 which reflects laser beam 14. Sensor 50 in FIG. 2a is a thermocouple, which is positioned via a heat insulating material 52 between back surface 48 of half mirror 24 and a shield plate 54 for shielding or absorbing the laser beam after transmitting through half mirror 24. In other words, sensor 50 is thermally-independent from the other components. Sensor 50 is positioned outside the laser beam after transmitting through half mirror 24 in a normal state. Therefore, sensor 50 is positioned so that sensor 50 does not receive the laser beam after transmitting through half mirror 24 in the normal state, and so that sensor 50 directly receives the laser beam after transmitting through half mirror 24 when (the diameter of) the laser beam is expanded or the beam axis of the laser beam is misaligned. This will be explained below.

FIG. 2b (3a) shows an example wherein, instead of thermocouple 50 described above, a generally annular thermopile 56, which is constituted by a plurality of thermocouples in series or in parallel, is arranged on back surface 48 of half mirror 24. Similarly to sensor 50, thermopile 56 is positioned outside the laser beam after transmitting through half mirror 24 in the normal state. Since the other components of FIG. 2b may be the same as FIG. 2a, the detailed explanation thereof is omitted.

FIG. 2c (3a) shows an example wherein, instead of thermocouple 50 described above, a plurality of thermostats 55 are arranged. Concretely, three thermostats 55 are positioned at equal distances on a circumference of a circle having a diameter larger than the diameter of the laser beam after transmitting through half mirror 24 in the normal state, or on a circumference of an ellipse having a minor radius larger than the diameter of the laser beam after transmitting through the half mirror. Although four or more thermostats 55 may be used and they may not be positioned at equal distances, it is preferable that they be positioned at equal distances. Further, the sensors may not be the same in type, for example, one thermocouple and two thermostats may be used. Since the other components of FIG. 2c may be the same as FIG. 2a, the detailed explanation thereof is omitted.

In this regard, the plurality of sensors (thermostats) are positioned on the circumference of the circle when the sensors are positioned on the same cross-section perpendicular to the traveling direction of laser beam 14, as shown in an enlarged view “A” of FIG. 1. On the other hand, the plurality of sensors are positioned on the circumference of the ellipse when the sensors are positioned parallel to half mirror 24 (or when the distance between each sensor and half mirror 24 is constant), as shown in an enlarged view “B” of FIG. 1.

FIG. 2d (3b) shows an example wherein, in addition to plurality of thermocouples 50, the other type of sensor (in this case, platinum resistance temperature detector) 58 is positioned adjacent to each thermocouple 50. Similarly to three thermocouples 50, three platinum resistance temperature detectors 58 are positioned at equal distances on a circumference of a circle having a diameter larger than the diameter of the laser beam after transmitting through half mirror 24 in the normal state, or on a circumference of an ellipse having a minor radius larger than the diameter of the laser beam after transmitting through the half mirror. In this regard, the circle or the ellipse where platinum resistance temperature detectors 58 are positioned includes the circle or the ellipse where thermocouples 50 are positioned. Since the other components of FIG. 2d may be the same as FIG. 2a, the detailed explanation thereof is omitted.

FIG. 2e (3c) shows an example wherein, in the configuration of FIG. 2a, thermocouple 50 is replaced with a temperature switch 59, and a mirror temperature sensor (in this case, a thermocouple for detecting the temperature of the mirror) 60 is attached to a front surface of half mirror 24. Since the other components of FIG. 2e may be the same as FIG. 2a, the detailed explanation thereof is omitted.

FIG. 2f (3d) shows an example wherein, in the configuration of FIG. 2a, a laser receiving part 62 such as a metallic part is attached to a front side of sensor 50. In the example of FIG. 2f, unlike the other examples, laser receiving part 62, not sensor 50, directly receives the laser beam when the laser beam is expanded or the axis of the laser beam is misaligned. Then, sensor 50 is configured to detect the temperature of laser receiving part 62 after laser receiving part 62 receives the laser beam. Since the other components of FIG. 2f may be the same as FIG. 2a, the detailed explanation thereof is omitted.

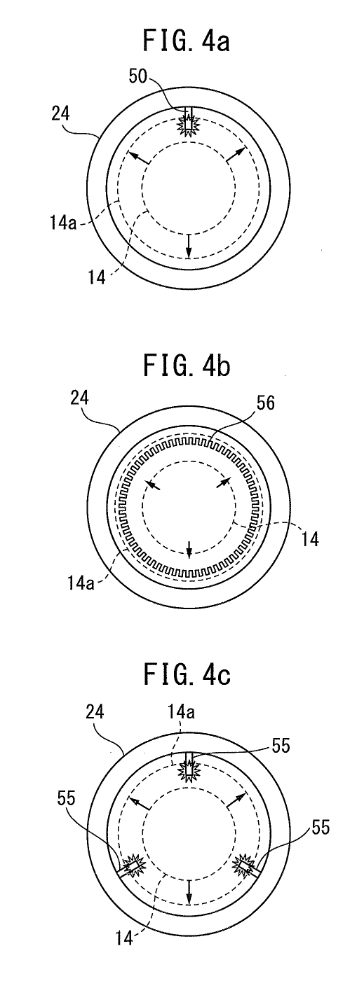

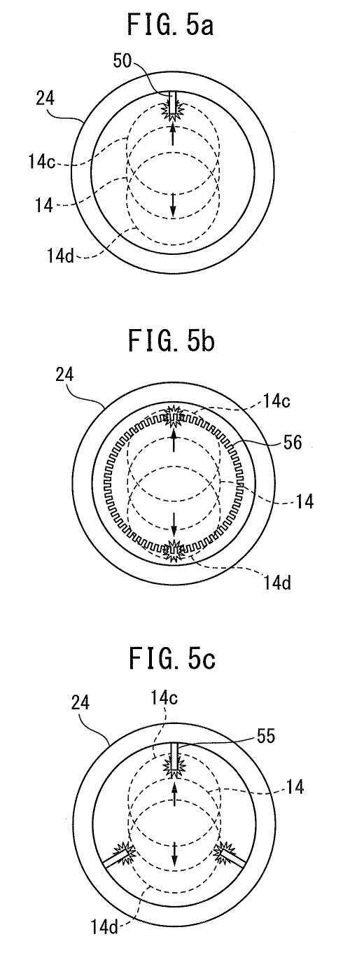

Next, the function of the above sensor will be explained with reference to FIGS. 4a to 4c and 5a to 5c. In this regard, FIGS. 4a to 4c show examples wherein the laser beam is expanded due to impurities entrapped into beam path 16, and FIGS. 5a to 5c show examples wherein the laser beam axis is misaligned from the normal state due to an error of orientation of the reflecting mirror or a defect of the laser oscillator, etc.

FIG. 4a shows an example wherein half mirror 24 having one thermocouple 50 (FIG. 2a) is irradiated with laser beam 14a which is expanded relative to the normal state, and a portion of the laser beam transmits through half mirror 24. Thermocouple 50 does not receive laser beam 14 in the normal state, but can directly receive expanded laser beam 14a. Further, as shown in FIG. 5a, even when the beam axis of laser beam 14 in the normal state is shifted upward (laser beam 14c), the shifted laser beam can be detected by sensor 50.

As described above, the sensor is positioned in place so that the sensor does not receive the laser beam after transmitting through half mirror 24 in the normal state, and directly receives the laser beam after transmitting through half mirror 24 only when the laser beam is expanded or the beam axis is misaligned, whereby the expansion of the laser beam or the misalignment of the beam axis of the laser beam can be easily and rapidly detected. In this regard, since the sensor receives the laser beam after transmitting through the half mirror (normally, a power of the laser beam is smaller than 2% of a power before transmitting through the half mirror), it is unlikely that the sensor is deformed by heat or hazardous vapors are generated from the sensor. Further, since the sensor does not receive the laser beam in the normal state, it may be judged that the laser beam is in the abnormal state immediately when the sensor receives the laser beam. Therefore, it is not necessary to quantitatively measure or evaluate an amount of light received. In addition, the substantially same effect may be obtained when the different types of sensors are positioned on the circumference of the same circle or ellipse.

On the other hand, as shown in FIG. 5a, when one sensor (thermocouple) 50 is used, the misalignment of the beam axis may or may not be detected depending on which direction the beam axis is shifted. For example, laser beam 14c which is shifted upward from laser beam 14 in the normal state can be detected by sensor 50, whereas laser beam 14d which is shifted downward from laser beam 14 in the normal state cannot be detected.

In such a case, by using generally annular thermopile 56 as shown in FIG. 2b, expanded laser beam 14a can be detected (FIG. 4b), further, the misalignment of the beam axis can be assuredly detected when the laser beam is shifted in any direction (FIG. 5b). Also, when sensors 55 as shown in FIG. 2c are positioned at equal distances on the circumference of the circle or the ellipse, expanded laser beam 14a can be detected (FIG. 4c), and the misalignment of the beam axis can be almost assuredly detected (FIG. 5c). As described above, by using the thermopile or the plurality of sensors, both the expansion of the laser beam and the misalignment of the beam axis can be detected, and the direction of the misalignment can be determined.

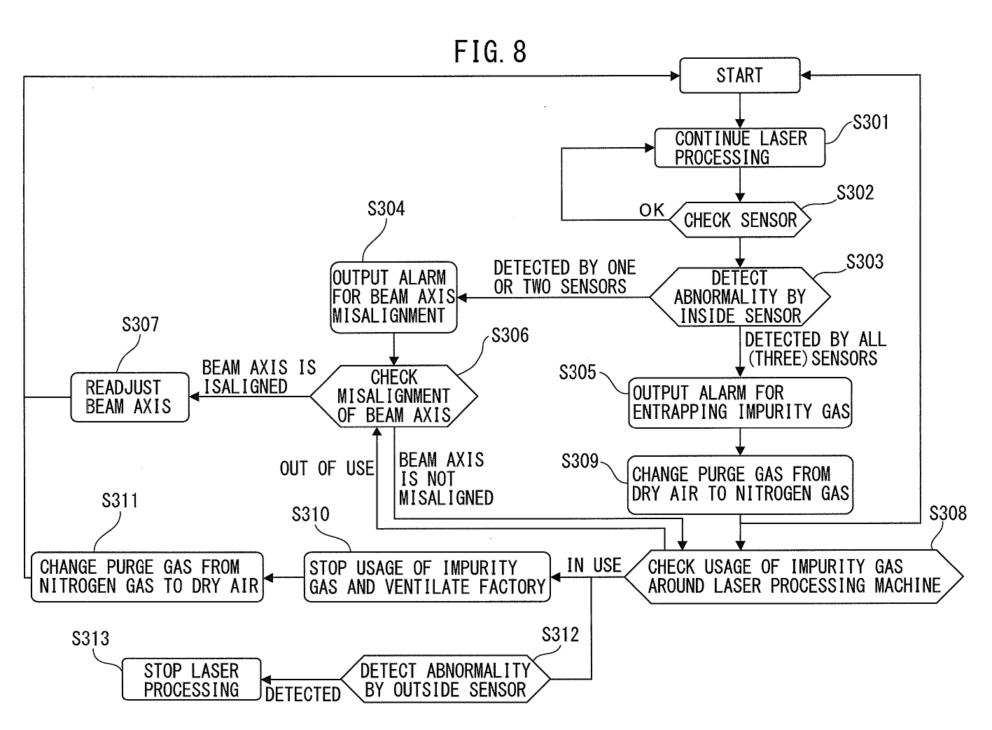

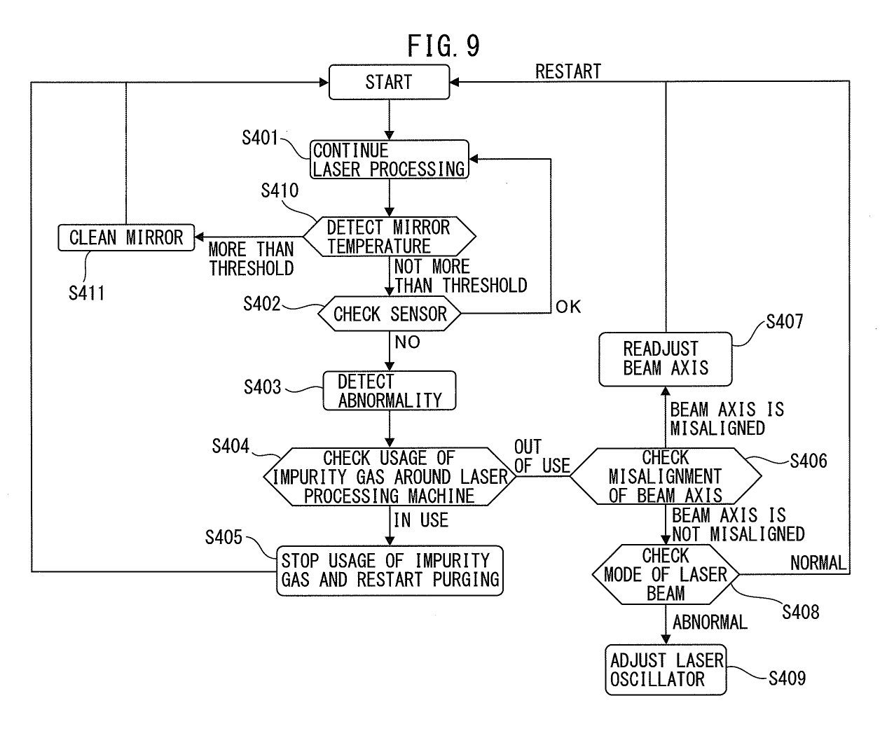

In the configurations of FIGS. 2d to 2f, at least the effect similar to FIG. 2a is obtained. As shown in FIG. 2d, when the different types of sensors (thermocouple 50 and resistance temperature detector 58) having different detecting ranges are used, a step-by-step procedure can be carried out depending on the degree of expansion of the laser beam, in addition to the effect similar to FIG. 2c (refer to a third flowchart (FIG. 8) as explained below). On the other hand, as shown in FIG. 2e, when a sensor 60 for measuring the temperature of half mirror 24 is arranged, a defect due to the thermal deformation or contamination of the half mirror can be detected (refer to a fourth flowchart (FIG. 9) as explained below).

As shown in FIG. 2f, when a light receiving part 62 is arranged on the front side of sensor 50, a wide area of half mirror 24 can be monitored by means of one sensor, by appropriately selecting the dimension and/or shape of light receiving part 62. On the other hand, since a heat-transferring action of light receiving part 62 is utilized in this case, the detection may delay relative to the case wherein the sensor directly receives the laser beam. Therefore, the sensor for directly receiving the beam (as shown in FIG. 2a) and the sensor for indirectly receiving the beam (as shown in FIG. 2f) may be combined so as to obtain the advantages of both types of sensors.

The sensors shown in FIGS. 2a to 2f are merely examples, and thus the type, the position or the number of the sensors may be changed and/or another type of sensor may be used, as long as the sensor does not receive the laser beam in the normal state and receives the laser beam after transmitting through the half mirror in the abnormal state. Further, the configuration or the type of the sensor may be modified or changed depending on which mirror in the laser processing device the sensor should be arranged, or on contents of the defect to be detected.

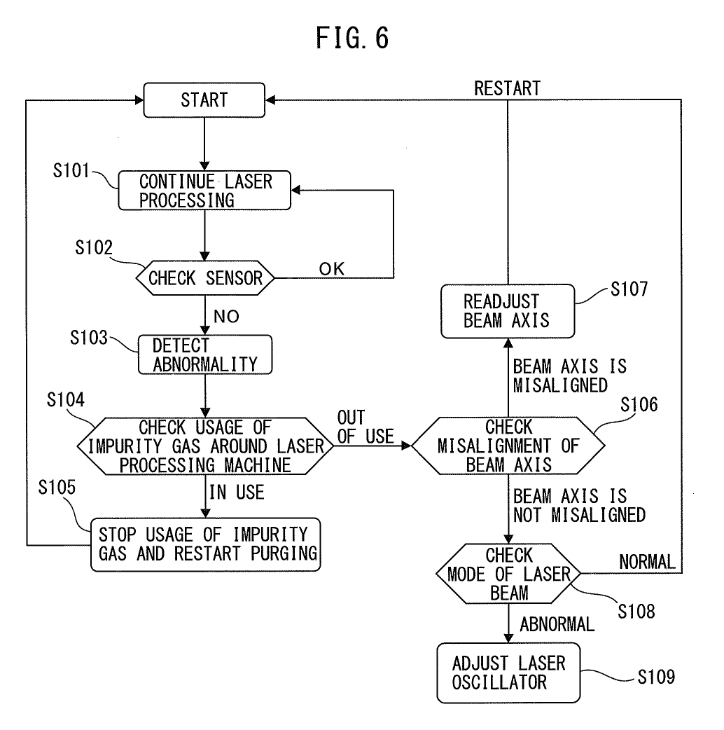

Next, with reference to first, second, third and fourth flowcharts (FIGS. 6 to 9), procedures for detecting the expansion of the laser beam and/or the misalignment of the beam axis, by using the half mirror having the configuration as shown in FIGS. 2a to 2f, will explained.

The first flowchart of FIG. 6 shows the procedure wherein the half mirror having the configuration of FIGS. 2a. 2b and 2f is used. First, the laser processing is initiated or continued (step S101), and it is monitored as to whether or not the sensor receives the laser beam (step S102). While the sensor does not receive the laser beam, the laser processing is continued. On the other hand, when the sensor receives the laser beam, it is judged that an abnormality occurs in the laser beam (step S103). However, in this moment, it cannot be determined as to whether the abnormality corresponds to the expansion of the laser beam or the misalignment of the beam axis. Therefore, in the next step S104, it is checked as to whether or not impurity gas is used around the laser processing device.

When the impurity gas is used, the laser processing can be continued by suspending the usage of the impurity gas and purging the beam path with purge gas (step S105). On the other hand, when the impurity gas is not used, the beam axis may be misaligned. Therefore, it is checked as to whether or not the beam axis is misaligned by using a proper means (step S106), and the beam axis is readjusted when the beam axis is misaligned (step S107).

On the other hand, when the misalignment of the beam axis is not monitored, a mode (or intensity distribution) of the laser beam is checked (step S108). If the mode has an abnormality, the laser processing is stopped and the laser oscillator is adjusted (step S109). When the mode of the laser beam does not have an abnormality, there may be a factor other than the impurity gas or the misalignment of the beam axis. Therefore, the factor should be investigated and removed.

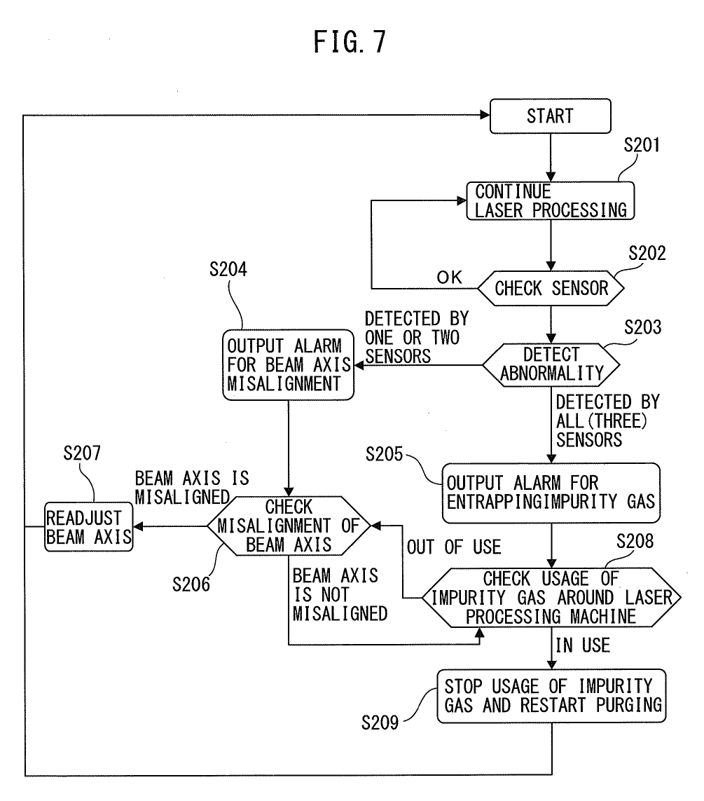

The second flowchart of FIG. 7 shows the procedure wherein the half mirror having the configuration of FIG. 2c is used. First, the laser processing is initiated or continued (step S201), and it is monitored as to whether or not the sensor receives the laser beam (step S202). While the sensor does not receive the laser beam, the laser processing is continued. On the other hand, when the sensor receives the laser beam, it is detected how many sensors receive the laser beam (step S203). Since the example of FIG. 2c includes three sensors (thermostats 55), when one or two sensors receive the laser beam, the abnormality of the laser beam is likely to be caused by the misalignment of the beam axis. Therefore, by using a proper means such as an alarm outputting part 64 which outputs or displays an alarm, an alarm representing the misalignment of the beam axis is output so as to give notice to the controller of the laser processing device and/or the operator (step S204). On the other hand, when all (in this case, three) sensors receive the laser beam, the abnormality of the laser beam is likely to be caused by the impurity gas (or the expansion of the laser beam). Therefore, by using a proper means such as alarm outputting part 64, an alarm representing the entrapment of the impurity gas into the beam path is output so as to give notice to the controller of the laser processing device and/or the operator (step S205).

When one or two sensors receive the laser beam, the procedure progresses to step S206, in which it is judged as to whether or not the beam axis is actually misaligned or shifted. When the misalignment occurs, the laser processing device can be made operational again, by readjusting the laser beam axis (step S207).

On the other hand, when the misalignment of the beam axis does not occur and all sensors receive the laser beam, the abnormality of the laser beam is likely to be caused by the impurity gas. Then, it is checked as to whether or not impurity gas is used around the laser processing device (step S208). When the impurity gas is used, the laser processing can be continued by suspending the usage of the impurity gas and purging the beam path with purge gas (step S209). On the other hand, when the impurity gas is not used while all sensors receive the laser beam, the beam axis may be misaligned. Therefore, it is checked as to whether or not the beam axis is misaligned (step S206), and the beam axis is readjusted when the beam axis is misaligned (step S207).

In addition, in the flowchart of FIG. 7, steps S206 and S208 may be alternately repeated when neither the usage of the impurity gas nor the misalignment of the beam axis is detected. In such a case, since there may be a factor other than the impurity gas or the misalignment of the beam axis, the factor should be investigated and removed.

The third flowchart of FIG. 8 shows the procedure wherein the half mirror having the configuration of FIG. 2d is used. First, the laser processing is initiated or continued (step S301), and it is monitored as to whether or not the sensor receives the laser beam (step S302). While the sensor does not receive the laser beam, the laser processing is continued. In this regard, since the configuration of FIG. 2d includes three inside sensors and three outside sensors (thermocouples 50 and platinum resistance temperature detectors 58), it is checked in first as to whether or not inside sensor 50 (nearer the laser beam in the normal state) receives the laser beam (step S303). When one or two of the inside sensors receive the laser beam, the abnormality of the laser beam is likely to be caused by the misalignment of the beam axis. Therefore, by using a proper means such as alarm outputting part 64, an alarm representing the misalignment of the beam axis is output so as to give notice to the controller of the laser processing device and/or the operator (step S304).

On the other hand, when all (in this case, three) inside sensors receive the laser beam, the abnormality of the laser beam is likely to be caused by the impurity gas (or the expansion of the laser beam). Therefore, by using a proper means such as alarm outputting part 64, an alarm representing the entrapment of the impurity gas into the beam path is output so as to give notice to the controller of the laser processing device and/or the operator (step S305), and then, the purge gas is changed from dry air to nitrogen gas (step S309). By changing the purge gas, the alarm can be prevented from being output.

When one or two of the inside sensors receive the laser beam, the procedure progresses to step S306, in which it is judged as to whether or not the beam axis is actually misaligned or shifted. When the misalignment occurs, the laser processing device can be made operational again, by readjusting the laser beam axis (step S307).

On the other hand, when the misalignment of the beam axis does not occur and all inside sensors receive the laser beam, the abnormality of the laser beam is likely to be caused by the impurity gas. Then, it is checked as to whether or not impurity gas is used around the laser processing device (step S308). When the impurity gas is used, the laser processing can be continued by suspending the usage of the impurity gas and ventilating the factory or building where the laser processing device is installed (step S310), and changing the purge gas from nitrogen gas to dry air (step S311). In other words, in case that the factor of the abnormality such as the impurity gas is removed while the purge gas is changed to nitrogen gas and the laser processing is continued, it is not necessary to suspend the laser processing. On the other hand, when the impurity gas is not used while all inside sensors receive the laser beam, the beam axis may be misaligned. Therefore, it is checked as to whether or not the beam axis is misaligned (step S306), and the beam axis is readjusted when the beam axis is misaligned (step S307).

When it is detected that the impurity gas is used (step S308), concurrently with step S310, it is monitored as to whether or not outside sensors 58 (farther from the laser beam in the normal state) receive the laser beam (step S312). When at least one outside sensor receives the laser beam, it can be judged that the laser beam is widely expanded. Therefore, in such a case, the laser processing is stopped (step S313).

As shown in FIG. 1, when the distance between laser oscillator 12 and half mirror 24 can be significantly varied, a threshold of the beam diameter may be different depending on the position of half mirror 24, wherein an alarm should be output when the beam diameter of the expanded laser beam exceeds the threshold. In such a case, the sensor having the configuration of FIG. 2d may be used in different ways: i.e., the procedure is carried out according to the flowchart of FIG. 8 when half mirror 24 is positioned relatively close to laser oscillator 12; and, inside sensors 50 are disabled and outside sensors 58 are used similarly to sensors 55 of FIG. 2c when half mirror 24 is positioned relatively away from laser oscillator 12.

In FIG. 2d, the inside sensors and the outside sensors are different types. However, the types of the sensors may be appropriately selected depending on a required response speed and/or a manner of receiving a signal, for example, the inside sensors and the outside sensors are the same type. Further, it is not necessary that each inside sensor is the same type, and thus the type of each inside sensor may be different. Similarly, it is not necessary that each outside sensor is the same type, and thus the type of each outside sensor may be different.

The fourth flowchart of FIG. 9 shows the procedure wherein the half mirror having the configuration of FIG. 2e is used. The procedure of FIG. 9 is the same as the flowchart of FIG. 1, except that a step S410 for measuring the temperature of half mirror 24 by means of a temperature sensor 60 attached to half mirror 24, and a step S411 for cleaning half mirror 24 depending on the measurement result in step S410 are inserted before step S402 for checking as to whether the sensor receives the laser beam.

The procedure of FIG. 9 is intended to clean half mirror 24 when the temperature of half mirror 24 exceeds a predetermined temperature threshold, taking into consideration that half mirror 24 is heated by absorbing the laser beam as the half mirror is polluted and then the half mirror may be deformed and/or reflected light and transmitted light at the half mirror may be adversely affected. By virtue of this, incorrect detection of the expansion of the laser beam and the misalignment of the beam axis can be avoided. Since steps in the flowchart of FIG. 9 other than steps S410 and S411 may be the same as in the flowchart of FIG. 6, a number 300 is added to the number of each step in FIG. 9 corresponding to the step in FIG. 6 (for example, step S401 in FIG. 9 corresponds to step S101 in FIG. 6), and the detailed explanation thereof will be omitted.

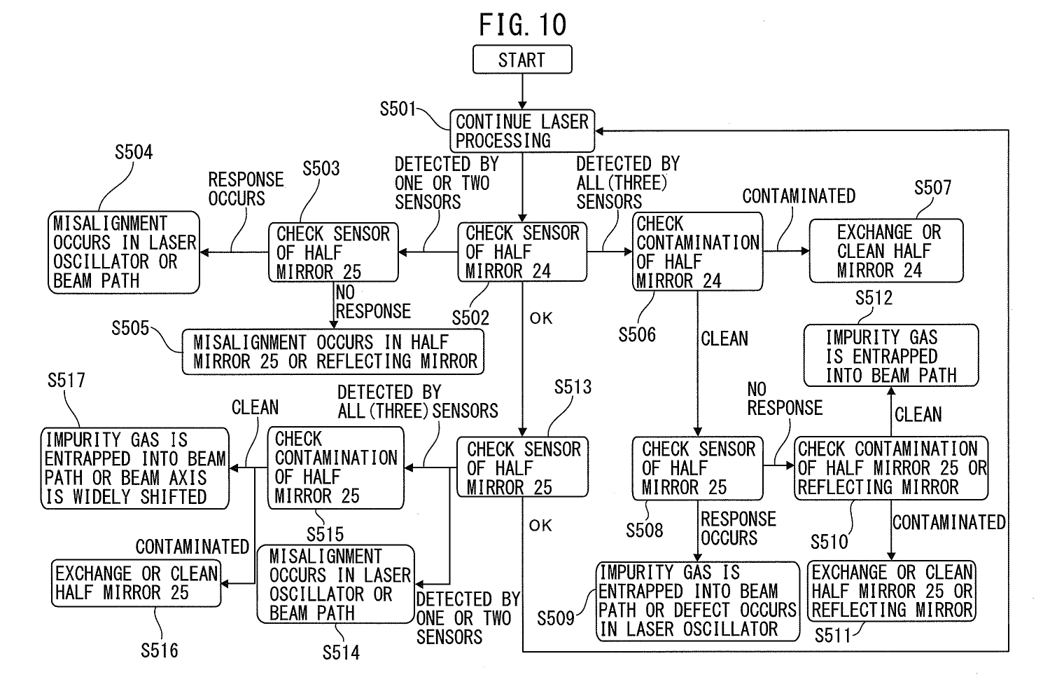

In the embodiment as explained above, laser processing device 10 has one half mirror 24 (concretely, in FIG. 1, a (third) mirror which is farthest from laser oscillator 12 is a half mirror). However, a plurality of half mirrors each having the above sensor may be positioned in beam path 16. In this regard, the fifth flowchart of FIG. 10 shows the procedure wherein the laser processing device of FIG. 1 has a configuration in which first reflecting mirror 20 closest to laser oscillator 12 is replaced with a half mirror (or a partially transmitting mirror) 25, and each of half mirrors 24 and 25 has three sensors (FIG. 2c).

First, the laser processing is initiated or continued (step S501), and it is monitored as to whether or not the sensor of half mirror 24 (farther from the laser oscillator) receives the laser beam (step S502). When one or two of the sensors receive the laser beam, it is monitored as to whether or not the sensor of half mirror 25 (nearer the laser oscillator) receives the laser beam (step S503). When at least one sensor of half mirror 25 receives the laser beam, it is judged that the laser oscillator or the beam axis is misaligned (step S504), and appropriate measures are carried out. On the other hand, when none of the sensors of half mirror 25 receives the laser beam, it can be judged that half mirror 25 or the other reflecting mirror is displaced or misaligned (step S505), and appropriate measures are carried out.

When all (three) sensors of half mirror 24 receive the laser beam in step S502, first, it is checked as to whether or not half mirror 24 is polluted (step S506), and then half mirror 24 is exchanged or cleaned when it is polluted (step S507). On the other hand, when half mirror 24 is not polluted, it is likely that the laser beam is expanded at the upstream side relative to half mirror 24, and thus it is monitored as to whether or not the sensor of half mirror 25 receives the laser beam (step S508). When at least one sensor of half mirror 25 receives the laser beam, it is judged that the impurity gas is entrapped into the beam path or the laser oscillator has a defect (step S509), and appropriate measures are carried out.

When none of the sensors of half mirror 25 receives the laser beam in step S508, half mirror 25 or the other reflecting mirror may be polluted, and thus it is checked as to whether or not half mirror 25 or the other reflecting mirror is polluted (step S510). If it is polluted, the polluted mirror is exchanged or cleaned (step S511). On the other hand, if it is not polluted, it is judged that the impurity gas is entrapped into the beam path (step S512), and appropriate measures are carried out.

When none of the sensors of half mirror 24 receives the laser beam in step S502, it is checked as to whether or not the sensor of half mirror 25 receives the laser beam (step S513). When none of the sensors of half mirror 25 receives the laser beam, the laser processing is continued (step S501). On the other hand, when one or two sensors of half mirror 25 receive the laser beam, it is judged that the laser oscillator or the beam axis is misaligned (step S514), and appropriate measures are carried out.

When all (three) sensors of half mirror 25 receive the laser beam in step S513, first, it is checked as to whether or not half mirror 25 is polluted (step S515), and then half mirror 25 is exchanged or cleaned when it is polluted (step S516). On the other hand, when half mirror 25 is not polluted, it is judged that the impurity gas is entrapped into the beam path or the beam axis is widely shifted or misaligned (step S517), and appropriate measures are carried out.

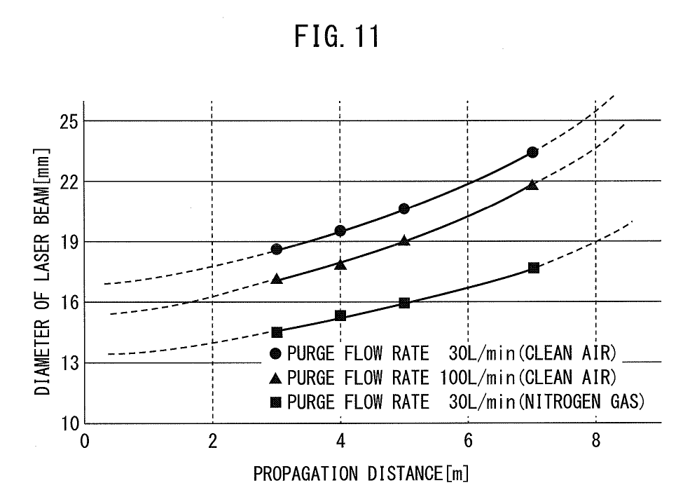

FIG. 11 is a graph showing propagation characteristics of a laser beam, concretely, showing the relationship between the propagation distance and the laser beam diameter wherein the kind and the flow rate of purge gas in the beam path are used as parameters. As shown in FIG. 11, the diameter of the laser beam depends on the kind and the flow rate of the purge gas and the distance from the laser oscillator (or the propagation distance), further, may be affected by beam absorption due to carbon dioxide gas in the air and/or concentration of gas composition which may scatter the laser beam. Therefore, the diameter of the laser beam can be calculated with respect to the distance from the laser oscillator, and the composition and the flow rate of the purge gas used.

By previously obtaining the graph or data as shown in FIG. 11, the beam diameter in the “normal state” as described above can be determined. For example, in the laser processing device of FIG. 1, the position of half mirror 24 can be varied within a range of 5 to 7 meters from laser oscillator 12, and thus the maximum diameter of the laser beam is 23.5 millimeters. The attachment position of the sensor on the half mirror may be appropriately determined based on the berm diameter in the normal state, a desired accuracy of the laser processing, and the material and thickness of the workpiece, etc. For example, the sensors may be positioned on or in a circumference of a circle having a diameter 1.2 to 2 times (preferably, 1.5 to 1.8 times) larger than the maximum beam diameter in the normal state.

In theory, tails or skirts of the laser beam spreads unlimitedly, and thus it is difficult to precisely define a boundary of the laser beam. Therefore, the “laser beam” herein means a (generally cylindrical) laser beam having the beam diameter as shown in FIG. 11. Further, the beam diameter is determined so that the above sensor such as a thermocouple does not have an abnormality even when the sensor receives a portion of the laser beam outside the determined beam diameter for a long time. For example, when the laser beam is asymmetric, by calculating a circle including a certain ratio of power among total power of the laser beam based on a peak power thereof, a diameter of the calculated circle may be determined as the maximum beam diameter. On the other hand, when the laser beam is generally symmetric, a position (or a circle) where irradiation intensity of the laser beam is equal to “1/e” (36.8%) or “1/e²” (13.5%) of the peak power may be determined as the beam diameter.

According to the present invention, at least one of the reflecting mirrors in the beam path is configured as a half mirror, and a sensor is arranged on the back side of the half mirror and is positioned outside the maximum diameter of the laser beam in the normal state. Therefore, the sensor can receive the laser beam only when the laser beam is expanded or the beam axis of the laser beam is misaligned, whereby the expansion and the misalignment of the laser beam can be easily detected. Since the sensor is not positioned in the beam path, an adverse effect due to the propagation of the laser beam or the retention of the purge gas does not occur. Further, since the power of laser beam after transmitting the half mirror is significantly reduced (normally, 2% or less), the sensor is not deformed by heat or hazardous vapors are not generated from the sensor. Since the power of the transmitted laser beam is very low, the sensor is not damaged by the transmitted laser beam, whereby the laser power and the position of the sensor can be optimized.

By positioning a plurality of sensors on a circle or an ellipse at equal distances, the expansion of the laser beam and the misalignment of the beam axis can be discriminated, and the direction of misalignment can also be determined.

By directly receiving the laser beam after transmitting through the half mirror by means of the sensor, the configuration of the sensor can be simplified and the abnormality in the laser propagation can be rapidly detected. Further, it is unlikely that such a sensor malfunctions relative to a gas sensor, etc., for monitoring atmosphere, and a continuous operation of the laser processing device is not adversely affected.

By using the mirror temperature sensor for measuring the temperature of the half mirror, the absorption or scattering of the laser beam due to the pollution or heat deformation of the half mirror can be previously detected, and further, detection accuracy of the expansion or misalignment of the laser beam can be improved.

By outputting an alarm immediately when an abnormality or defect in the laser processing device occurs, a loss due to defective products can be minimized.

While the invention has been described with reference to specific embodiments chosen for the purpose of illustration, it should be apparent that numerous modifications could be made thereto, by one skilled in the art, without departing from the basic concept and scope of the invention.

1. A laser processing device comprising:
a laser oscillator;
a beam path through which a laser beam, which is output from the laser oscillator, transmits; and
at least one reflecting mirror positioned in the beam path, the laser beam propagating within the beam path,
wherein the at least one reflecting mirror includes at least one half mirror, and at least one sensor is arranged on a surface of the half mirror opposed to a surface where the laser beam is reflected, the sensor being configured to receive the laser beam after transmitting through the half mirror, and
wherein the sensor is positioned so that the sensor does not receive the laser beam in a normal state, and so that the sensor receives the laser beam when the laser beam is expanded relative to the normal state or when a beam axis of the laser beam is misaligned relative to the normal state.

2. The laser processing device as set forth in claim 1, wherein the at least one sensor includes a plurality of sensors, and the sensors are positioned at equal distances on a circumference of a circle having a diameter larger than a diameter of the laser beam after transmitting through the half mirror, or on a circumference of an ellipse having a minor radius larger than the diameter of the laser beam after transmitting through the half mirror.

3. The laser processing device as set forth in claim 1, wherein the sensor is configured to directly receive the laser beam after transmitting through the half mirror.

4. The laser processing device as set forth in claim 1, further comprising a mirror temperature sensor configured to measure a temperature of the half mirror.

5. The laser processing device as set forth in claim 1, wherein the sensor is selected from a group including a thermocouple, a temperature switch, a thermostat, a thermopile, and a platinum resistance temperature detector.

6. The laser processing device as set forth in claim 1, further comprising an alarm outputting part configured to output an alarm when the sensor receives the laser beam.
